(19) United States
(12) Patent Application Publication
(10) Pub. No.: US 2019/0237737 A1
(43) Pub. Date: Aug. 1, 2019

(54) BATTERY

(71) Applicant: SAFT, Levallois-Perret (FR)

(72) Inventors: Thierry BERLUREAU, Bordeaux (FR); Gerard RIGOBERT, FARGUES St HILAIRE (FR)

(73) Assignee: SAFT, Levallois-Perret (FR)

(21) Appl. No.: 16/339,093

(22) PCT Filed: Oct. 4, 2017
(86) PCT No.: PCT/EP2017/075235

§ 371 Date: Apr. 3, 2019

(30) Foreign Application Priority Data
Oct. 4, 2016 (FR) 1659580

(51) Int. Cl. H01M 2/26; H01M 4/485; H01M 4/66; H01M 2/02; H01M 2/30; H01M 10/0525; H01M 10/0587

(52) U.S. Cl. CPC H01M 2/263; H01M 4/485; H01M 4/661; H01M 2/0287; H01M 2/0277; H01M 2/024; H01M 2/0275; H01M 2/30; H01M 2/022; H01M 10/0525; H01M 10/0587; H01M 2/0285

(57) ABSTRACT

The invention relates to a battery, in particular a lithium-ion type battery. The battery comprises a container (1) containing an electrochemical bundle with alternating positive and negative electrodes (2) framing electrolyte-impregnated separators, and at least one current output terminal (3, 4) forming a cover (3, 4) for closing the container (1). The edges (5, 6) of the electrodes (2) having one of the polarities are directly connected to the cover (3, 4) by welding.

### FIELD OF THE INVENTION

The present invention relates to a secondary cell or battery, in particular to a cell of the lithium-ion type. It finds particular application in areas as diverse as communication devices or laptop computers, electric vehicles or standby power systems.

### BACKGROUND OF THE INVENTION

The storage of electrical energy is a booming field, especially due to the opening up of new markets for example linked to infrastructure needs, transition from fossil fuels, the Internet of things and more generally to connectivity between various system components. Secondary cells are an appropriate response to this need by storing electrical energy.

Among the different technologies used, lithium-ion technology is increasingly present. Batteries of the lithium ion type are indispensable for example for phones or laptops, but also for electric vehicles. They are also found increasingly in traditional industrial fields that use batteries. One reason for their success comes from their excellent energy density per volume, with their price steadily declining.

In this technology, one generally uses a thin strip of copper as a support for the negative electrodes and a thin strip of aluminum as the support for the positive electrodes. The strip is coated with a paste comprising the electrochemically active material, except at its ends which are not covered with this material over a portion of a few millimeters. The uncoated portion is used to weld the strip to one end of a connecting piece, of copper in the case of a copper thin strip, the function of which is to collect current from the electrodes. The other end of this connecting piece is welded to a current output terminal, the positive or negative terminal depending on the polarity of the electrodes concerned,

A secondary cell generally comprises a container, preferably of cylindrical shape, closed at at least one of its ends by a closure member. The container includes an electrode plate group which is obtained by winding alternating positive and negative electrodes separated by a separator. The closure member serves as a current output terminal. A secondary cell of this type is known from Chinese utility model Publication number CN201243063. As described therein, the connection between the electrode plate group and the closure member is achieved by means of a plurality of current collecting strips.

One of the problems associated with the use of one or more connection parts between the closure member and the electrode plate group is the increase in contact resistance. The contact resistance and the small cross-section for passage of current lead to poor heat dissipation and to electric power loss. Thus, heat dissipation, and power and energy densities per volume, in other words energy density, are not optimal.

Another problem associated with the use of one or more connection parts between the closure member and the electrode plate group lies in the assembly process which becomes complicated and costly to implement. Besides the cost of the at least one intermediate connection parts themselves, their assembly by welding, firstly, to the closure member and, secondly, to the electrode plate group increases manufacturing time and cost.

### SUMMARY OF THE INVENTION

One aim of the invention is therefore to solve the particular problems set out above. In particular, the invention has the aim of providing a secondary cell that is easier and less expensive to manufacture and which has improved energy performance and heat dissipation.

The invention provides a secondary cell comprising a container containing an electrode plate group. The electrode plate group comprises alternating positive and negative electrodes flanking separators impregnated with electrolyte. The secondary cell also includes at least one current output terminal forming a closure member closing off the container.

The edge portions of the electrodes of one polarity are connected directly to the closure member by welding.

The term “edge portions” of the electrodes refers to bands of the electrodes which are uncoated at each of the lateral ends of these electrodes, that is to say the uncoated bands at the negative polarity end and forming the anode of the electrode plate group, and uncoated bands at the positive polarity end, thereby forming the cathode of the electrode plate group.

In certain embodiments, the secondary cell further comprises one or more of the following features, alone or in all technically feasible combinations:
the edge portions of the electrodes are compacted and form a connection portion of extra thickness which is welded directly to the closure member;
the secondary cell comprises a hollow tube of central axis (A) about which the electrode plate group is wound, and the edge portions of the electrodes of the electrode plate group are distributed substantially evenly and circularly around said axis (A) near one end of said hollow tube;
the secondary cell comprises a hollow tube having an axis (A) about which the electrode plate group is wound, and the closure member is provided at its center and on its face directed towards the interior of the container, with an inner projection which fits into one end of the hollow tube;
the inner projection forms an outer recess for connection at the outwardly directed face of the closure member of the container, so as to allow electrical connection with another secondary cell, by cooperation of a male-female type with an external projection for connection disposed at a center of a closure member for closing the said other secondary cell container, at the face directed towards the outside of the container of the said other secondary cell;
the outer recess for connection is threaded, to allow cooperation of a male-female screwed connection type by screwing an external threaded projection disposed at a center of the closure member for closing the container of the other secondary cell, on the face directed towards the outside of the container of the other secondary cell.
the closure member is provided at its center and on its face directed towards the exterior of the container, with an external connecting projection, so as to allow electrical connection with another secondary cell, by cooperation of a male-female type with an outer recess for connection disposed at the center of a closure member for closing the container of said other secondary cell, on the face directed towards the outside of the container of this other secondary cell;
the external projection for connection is threaded, to allow cooperation of a male-female type by screwing into a threaded outer recess for connection disposed at a center of the closure member for closing the container of the other secondary cell, on the face directed towards the outside of the container of this other secondary cell;
the container comprises a film of electrically insulating material, wherein the film is of flexible material, closed on itself by welding so as to form a flexible casing, within which an electrode plate group is disposed;
the film is of plastics material, such as polyester, polyethylene (PE), polypropylene (PP), or poly-ethylene terephthalate (PET).
the film is of laminated material comprising at least a metal thin strip such as aluminum thin strip, inserted between two plastic thin strips, such as thin strips made of polyester, polyethylene (PE), polypropylene (PP), or poly-ethylene terephthalate (PET);
the container comprises an outer tube of electrically insulating, rigid or semi-rigid material such as a plastic material such as polypropylene (PP) or polyester (PE);
the outer tube covers the flexible casing;
the closure member of the container is crimped onto the outer tube or onto the flexible casing;
the closure member of the container is bonded to the inner wall or the outer wall of the outer tube or of the flexible casing;
the closure member of the container is welded to the inner wall or the outer wall of the outer tube or the flexible casing;
the container comprises an outer filamentary reinforcement, preferably of plastic material such as a glass fiber-reinforced polyester film or tape, wound around the flexible casing or the outer tube;
the electrode plate group is of the lithium-ion type.
the positive electrodes are formed on an aluminum substrate, and the negative electrodes are formed on a copper substrate.
the electrode plate group is of a lithium titanate oxide or LTO type.
the positive and negative electrodes are formed on an aluminum substrate.

Thus, the cell of the invention is almost solely based on its core consisting of its wound electrochemical structure, which gives it optimal energy performance and heat dissipation, with a flexible casing and a mechanical structure that are reduced to a minimum.

Indeed the direct connection between the electrochemical core of the secondary cell and the closure member which acts as a positive or negative terminal for current output to the user limits electrical contact resistance. The secondary cell thus has an energy and a power density close to the maximum and excellent heat dissipation.

In addition, the manufacture of the secondary cell requires very little mechanical parts, which reduces the manufacturing cost, weight and volume of the secondary cell

The features and advantages of the invention will become apparent from reading the following description given purely by way of example and not limitation, with reference to the drawings.

### BRIEF DESCRIPTION OF THE DRAWINGS

FIG. 1 is a diagrammatic illustration of a first example of the secondary cell of the invention.

FIG. 2 is a diagrammatic illustration of a second example of secondary cell of the invention.

FIG. 3 is a diagrammatic illustration of another example showing the closure member forming the positive or negative terminal of the secondary cell according to the invention.

FIG. 4a is a diagrammatic illustration of an example of the assembly of the secondary cell container according to the invention.

FIG. 4b is a diagrammatic illustration of another example of the assembly of the secondary cell container according to the invention.

FIG. 5 is a diagrammatic illustration of another example of the closure member forming the positive or negative terminal of the secondary cell according to the invention, and its assembly with the container.

### DETAILED DESCRIPTION OF EMBODIMENTS

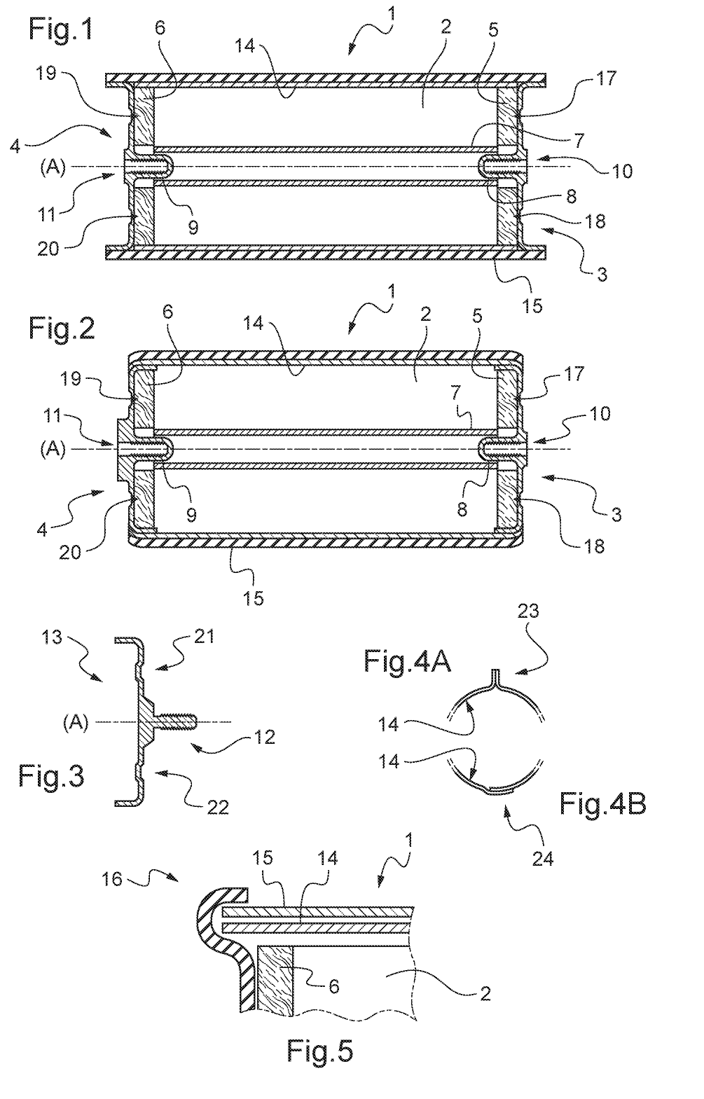

A secondary cell comprising an electrode plate group 2 contained in a container 1 can be seen in the example shown in FIG. 1.

The electrode plate group 2 is constituted by alternating positive and negative electrodes 2 flanking separators which are impregnated with electrolyte.

The container 1 has two ends each closed by a closure member 3, 4. Each of the closure members 3, 4 forms a terminal 3, 4, one positive and the other negative.

The edge portions 5, 6 of the electrodes are connected directly to one of the two closure members 3, 4 by welding, which is preferably carried out by laser, depending on the polarity of the electrodes in question. Thus, for example, the edge portions 5 of the positive electrodes are connected by welding directly to the closure member 3 forming a positive terminal for current output, and the edge portions 6 of the negative electrodes are connected by welding directly to the closure member 4 forming the negative terminal for current output.

In the case of an electrode plate group 2 for a lithium ion type secondary cell, the positive electrodes are formed on an aluminum substrate, and the negative electrodes are formed on a copper substrate.

Alternatively, in the more specific case of lithium-ion technology in which the negative electrode of the electrode plate group 2 is of the lithium titanate oxide (LTO) type, the strip for the negative electrodes can be also made of aluminum so that the positive electrodes just like the negative electrodes are formed on an aluminum substrate. This type of electrode plate group 2 offers the advantage of extremely rapid charge and discharge times, and consequently high electrical power.

As said, the edge portions 5, 6 of the electrodes are bands of the electrode which are uncoated at each one of the lateral ends of these electrodes. The uncoated edge portion bands 6 at the negative polarity end form the anode of electrode plate group 2, and the uncoated edge portion bands 5 of positive polarity form the cathode of the electrode plate group 2.

Spot weld points or weld lines 17, 18, 19, 20 are shown in FIG. 1, at the respective contacts between the edge portions 5, 6 of the electrode plate group 2 and the closure members 3, 4.

These edge portions 5, 6 are preferably compacted in accordance with what is described for example in EP 1,596,449. These compacted edge portions 5, 6 then each form a connection portion of extra thickness 5, 6, which is welded directly to one of the closure members 3, 4.

Compaction of the edge portions 5, 6 facilitates optimum connection of these edge portions 5, 6 to the electrical contact surface.

As shown in the example of FIG. 1, the electrode plate group 2 is wound around a hollow tube 7 with a central axis (A).

The edge portions 5, 6 of the electrodes 2 are thus distributed uniformly in a circular fashion about the axis (A), each of them near one end of the hollow tube 7.

In the example of FIG. 1, each of the circular closure members 5, 6 is provided at its center, on its face directed towards the inside of the container 1, with a projection 8, 9, for insertion into one end of hollow tube 7.

In this embodiment, the inner projections 8, 9 are hollow at the respective outwardly-directed faces of the closure members 3, 4 of container 1. Thus, an outer recess 10, preferably threaded, is formed inside interior projection 8, and an outer recess 11, also preferably threaded, is formed inside interior projection 9.

The said outer recesses 10, 11 are used to electrically connect the closure members 3, 4 with the closure member of another secondary cell and which takes for example the form of the closure member 13 shown in FIG. 3. This closure member 13 has an external projection 12, preferably threaded, formed at the center of its outer surface, that is to say on the outwardly-directed face of the container when the closure member 13 is assembled with a container 1 such as that of FIG. 1 to form another secondary cell.

Thus, the outer recesses 10, 11 of the secondary cell of FIG. 1 make it possible to electrically connect the secondary cell with another secondary cell provided with a closure member 13 such as that shown in FIG. 3, by cooperation of the male-female type between the external projection of closure member 13 of FIG. 3 and one of the outer recesses 10, 11 of the respective closure members 3, 4 of the secondary cell of FIG. 1.

When the outer recesses 10, 11 are threaded and the external projection 12 is threaded, the cooperation of a male-female type mentioned above can be secured by screwing the external projection 12 into one of the outer recesses 10, 11.

In the example of FIG. 1, the container 1 comprises a film 14 closed on itself by welding, so as to form a flexible casing 14 within which the electrode plate group 2 is disposed.

Examples of closure of the flexible casing 14 are shown respectively in FIG. 4a and FIG. 4b.

In the case of FIG. 4a, the weld 23 is obtained by overlapping the inner wall of both ends of the film 14. This variant is simple to realize, it leaves however a risk of leakage.

In the case of FIG. 4b, the weld 24 which is more efficient in terms of limiting leakage, is obtained by overlap of the inner wall of one end of the film 14 onto the outer wall of the other end of the film 14.

This film 14 is made of electrically insulating flexible material. It can be a film of flexible plastic material, such as a polyester (PPS, PBT, . . . ), polyethylene (PE), polypropylene, or poly-ethylene terephthalate (PET). It can also be a laminated film material comprising one or more metal thin strips inserted between plastic thin strips. In this case, the metal thin strip or strips may be aluminum thin strips and the plastic thin strips may be in one of the above plastic materials.

The use of such a film 14 makes it possible to minimize the bulk of the secondary cell, and thus improve energy density by volume.

As can be seen in FIG. 1, the respective edges of the closure members 3, 4 are sealingly assembled with the flexible casing 14, for example by welding or bonding.

For a welded joint with the closure members 3, 4 of metal, for example aluminum, the metal of closure members 3, 4 is prepared with a suitable surface treatment, such as phosphoric anodization.

In the variant of FIG. 1, the respective edges of the closure members 3, 4 are bent outwardly of the container 1, the connection between these edges and the flexible casing 14 then being created at the respective inner faces of the closure members 3, 4, that is to say the faces directed towards the interior of the container 1.

In the variant of FIG. 2, which in all other respects is identical to the variant of FIG. 1, the respective edges of the closure members 3, 4 are bent inwardly of the container 1, the connection between these edges and flexible casing 14 then being created at the respective outer faces of the closure members 3, 4, that is to say the faces directed outwardly from the container 1.

As shown in FIGS. 1 and 2, provision may be made to member the flexible casing 14 with a thin outer tube 15 made of electrically insulating and rigid or semi-rigid material such as a plastic material such as polypropylene (PP).

Alternatively, this outer tube 15 can replace the flexible casing 14. Thus, in the two respective variants shown in FIGS. 1 and 2, the container 1 comprises a flexible casing 14 covered with an outer tube 15. But in another variant which is not illustrated, the container 1 may comprise the outer tube 15 without the flexible casing 14.

The use of an electrically insulating material as the flexible casing material 14 and/or the outer tube 15, and thus of container 1, makes it possible for the opposite polarity terminals formed by the closure members 3, 4 to have a high insulation voltage which is distinctly greater than that of electrochemical cells of the prior art.

In either case, the connection between the respective edges of the closure members 3, 4 with the flexible casing 14 or the outer tube 15 may be obtained by welding or by bonding, or by a combination of both.

Depending on the embodiment and the respective shapes of the closure members 3, 4, assembly can be performed at the inner wall or the outer wall of flexible casing 14 or outer tube 15. In both examples shown respectively in FIGS. 1 and 2, assembly is performed at the inner wall of the flexible casing 14.

In yet another variant, shown partially in FIG. 5, one can provide for the assembly of the closure member or closure members onto container 1 to be performed by crimping. Thus, in this example, the closure member 16 is crimped around the end of flexible casing 14 and outer tube 15. Crimping is then performed against the inner wall of the flexible casing 14 and against the outer wall of outer tube 15.

Of course, this embodiment shown in FIG. 5 may itself be the object of sub-variants, in particular depending on the presence or absence of the flexible casing 14, and the presence or absence of the outer tube 15.

One can also provide an external filamentary reinforcement, not shown in the drawings, wound around the flexible casing 14 or the outer tube 15. This filamentary reinforcement, preferably made of plastic material, may take the form of a film or tape, for example of polyester reinforced with glass fiber.

This description is given by way of example and is not restrictive of the invention.

In particular, the invention is not limited to the shape of secondary cells having an overall cylindrical shape. Shapes other than a cylindrical shape, such as shapes that are centered on the central axis (A) of tube 7 around which the electrode plate group 2 is wound, can be envisaged.

Also, the invention is not limited to the selection of particular plastic materials for the various components of the container 1, such as film 14, outer tube 15, and the filamentary reinforcement.

1-22. (canceled)

23. A secondary cell comprising a container containing an electrode plate group having alternating positive and negative electrodes flanking separators impregnated with electrolyte, and at least one current output terminal forming a closure member closing off the container, wherein edge portions of the electrodes of one polarity are connected directly to said closure member by welding.

24. The secondary cell according to claim 23, wherein the edge portions of the electrodes are compacted and form a connection portion of extra thickness which is welded directly to the closure member.

25. The secondary cell according to claim 23, further comprising a hollow tube of central axis (A) about which the electrode plate group is wound, wherein the edge portions of the electrodes of the electrode plate group are distributed substantially evenly and circularly around said axis (A) near one end of said hollow tube.

26. The secondary cell according to claim 23, further comprising a hollow tube having an axis (A) about which the electrode plate group is wound, and the closure member is provided at its center and on its face directed towards the interior of the container with an inner projection which fits into one end of the hollow tube.

27. The secondary cell according to claim 26, wherein the inner projection forms an outer recess for connection at the outwardly directed face of the closure member of the container, so as to allow electrical connection with another secondary cell by cooperation of a male-female type with an external projection for connection disposed at a center of a closure member for closing the said other secondary cell container, at the face directed towards the outside of the container of the said other secondary cell.

28. The secondary cell according to claim 27, wherein the outer recess for connection is threaded, so as to allow cooperation of a male-female screwed connection type by screwing an external threaded projection disposed at a center of the closure member for closing the container of the other secondary cell, on the face directed towards the outside of the container of the other secondary cell.

29. The secondary cell according to claim 23, wherein the closure member is provided at its center and on its face directed towards the exterior of the container, with an external connecting projection, so as to allow electrical connection with another secondary cell by cooperation of a male-female type with an outer recess for connection disposed at the center of a closure member for closing the container of said other secondary cell, on the face directed towards the outside of the container of this other secondary cell.

30. The secondary cell according to claim 29, wherein the outer projection for connection is threaded, so as to allow cooperation of a male-female type by screwing into a threaded outer recess for connection disposed at a center of the closure member for closing the container of the other secondary cell, on the face directed towards the outside of the container of this other secondary cell.

31. The secondary cell according to claim 23, wherein the container comprises a film of electrically insulating material.

32. The secondary cell according to claim 31, wherein the film is of flexible material, closed on itself by welding to form a flexible casing, within which an electrode plate group is disposed.

33. The secondary cell according to claim 31, wherein the film is of plastics material.

34. The secondary cell according to any one of claim 33, wherein the film is of polyester, polyethylene (PE), polypropylene (PP), or poly-ethylene terephthalate (PET).

35. The secondary cell according to claim 31, wherein the film is of laminated material comprising at least a metal thin strip, inserted between two plastic thin strips.

36. The secondary cell according to claim 35, wherein the metal thin strip is an aluminum thin strip.

37. The secondary cell according to claim 35, wherein the plastic thin strips are made of polyester, polyethylene (PE), polypropylene (PP), or poly-ethylene terephthalate (PET).

38. The secondary cell according to claim 23, wherein the container comprises an outer tube of electrically insulating, rigid or semi-rigid material.

39. The secondary cell according to claim 38, wherein the plastic material of the outer tube is polypropylene (PP) or polyester (PE).

40. The secondary cell according to claim 32, wherein the outer tube covers the flexible casing.

41. The secondary cell according to claim 32, wherein the closure member of the container is crimped onto the outer tube or onto the flexible casing.

42. The secondary cell according to claim 32, wherein the closure member of the container is bonded to the inner wall or the outer wall of the outer tube or of the flexible casing.

43. The secondary cell according to claim 32, wherein the closure member of the container is welded to the inner wall or the outer wall of the outer tube or the flexible casing.

44. The secondary cell according to claim 32, wherein the container comprises an outer filamentary reinforcement, wound around the flexible casing or the outer tube.

45. The secondary cell according to claim 44, wherein the outer filamentary reinforcement is of plastic material.

46. The secondary cell according to claim 45, wherein the outer filamentary reinforcement is a glass fiber-reinforced polyester film or tape.

47. The secondary cell according to claim 23, wherein the electrode plate group is of the lithium-ion type.

48. The secondary cell according to claim 47, wherein the positive electrodes are formed on an aluminum substrate, and the negative electrodes are formed on a copper substrate.

49. The secondary cell according to claim 47, wherein the electrode plate group is of a lithium titanate oxide or LTO type.

50. The secondary cell according to claim 49, wherein the positive and negative electrodes are formed on an aluminum substrate.
